(19) United States
(12) Patent Application Publication
(10) Pub. No.: US 2008/0054019 A1
(43) Pub. Date: Mar. 6, 2008

(54) System for indicating contents of a product and engaging the user

(75) Inventors: Jeffrey James Stechschulte, Cincinnati, OH (US); Philip Andrew Sawin, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/515,529

(22) Filed: Sep. 5, 2006

(51) Int. Cl. B05B 11/00

(52) U.S. Cl. 222/78; 222/321.1

(57) ABSTRACT

An identification system for a product within a dispenser includes a product container arranged to dispense a product, a shaped feature coupled to the product container and which may take the form of an anthropomorphic head or other suitable shape, and an identification symbol coupled to the shaped feature, with the symbol suggesting the nature of the contents of the product container.

### FIELD OF THE INVENTION

The present disclosure generally relates to containers for dispensing products and, more particularly, to identification symbols or elements on product dispensers that facilitate a child's identification of the type of product contained in the product dispenser and encourage the use of the product.

### BACKGROUND OF THE INVENTION

Various types of product dispensers are generally known in the art. Such dispensers may hold liquid, solids, gels, or other products, or a combination of such products. Increasingly, many products are being specifically marketed for use by children. For example, liquid soap, shampoo, baby powder, oral hygiene products, and the like, are marketed using packaging and advertising intended to draw the attention of a child. In many cases, the container and/or packaging provided with the product dispenser is modified to have a decorative external appearance.

Some product containers in the prior art have been provided with three-dimensional components that provide an attractive shape to the container, such that the container resembles a fanciful object, an animal, a cartoon character, or other shape that would draw the attention of a child. Such attractive shapes may generate enthusiasm for performing the hygiene task associated with the product. As many parents know all too well, this enthusiasm may not exist in the absence of a dispenser having an attractive appearance.

Further, it can be appreciated that different intended users of the product may have different points-of-view as to the attractiveness of the dispenser and may result in different degrees of enthusiasm regarding the use of the product therein. For example, a package which includes flowers, rainbows, teddy-bears and the like may be attractive to a female child while a dispenser comprising a football helmet, racecars, weapons and the like may be attractive to a male child. Also, the long-term attractiveness of a dispenser may dissipate over time unless the attractiveness of the dispenser can be refreshed, periodically, with new and/or different identification symbols.

While these attractive, decorative dispensers have been designed to appeal to a child, in general they are not useful to a child who cannot read and yet wants to identify the contents of the dispenser. The reading skills of many young children can be quite limited, if not entirely non-existent. As a result, small children may not be able to read even the simplest words, and thus these children are not able to identify the contents of a specific dispenser. While the child may be able to ask an adult or perhaps another child with better reading skills, some children are hesitant to ask for help because they fear their lack of reading skills may be perceived by others as a lack of intelligence. Other children may fear that the inability to read indicates a generalized lack of capability. In other situations, the child may be alone and simply has nobody to ask for assistance.

In other situations, the child may simply have a preference to access the product from the dispenser, and use it, without the aid of an adult. This can be a particular problem in the case of personal hygiene products, e.g., while the child is potty-training. At this stage in the child's development he or she is typically trying to assert independence with regard to the parent, and will be more inclined to use the product in the event that he or she can do so without the aid of the parent.

In sum, although previous product dispensers tend to be successful in attracting a child's attention and/or to influence a purchasing decision, existing product dispensers do not address the need to tailor the attractiveness of the dispenser to a particular user or the difficulties of maintaining the child's interest in the continued use of the products. Further, these dispensers do not address the difficulties many children encounter when trying to identify the particular product contained within a product dispenser. These existing product dispensers may ultimately cause frustration and discourage the child from further use of the product.

### SUMMARY OF THE INVENTION

A system for indicating the contents of a product dispenser and for encouraging the use of a product dispenser is provided that includes a product dispenser arranged to contain a dispensable product and at least one shaped feature mounted to the product dispenser. A non-written identification symbol is mounted on the shaped feature(s), and the identification symbol is structured to indicate the nature of the dispensable product to a user and/or to enhance the attractiveness of the dispenser to the intended user.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a perspective view of an identification system for a product dispensing container;

FIG. 2 is a front view of the identification system of FIG. 1;

FIG. 3 is a front view of an alternate embodiment of an identification system constructed in accordance with the teachings of the disclosure;

FIG. 4 is a front view of another alternate embodiment of an identification system;

FIG. 5 is a front view of yet another alternate embodiment of an identification system;

FIG. 6 is a front view of yet another alternate embodiment of an identification system;

FIG. 7 is a front view of yet another alternate embodiment of an identification system;

FIG. 8 is a front view of the embodiment of FIG. 3 with an additional identification symbol added to the identification system;

FIG. 9 is a front view of yet another alternate embodiment of an identification system;

FIG. 10 is a front view of yet another alternate embodiment of an identification system;

FIG. 11 is a front view of yet another alternate embodiment of an identification system;

FIG. 12 is a front view of yet another alternate embodiment of an identification system; and

FIG. 13 is a front view of yet another alternate embodiment of an identification system.

### DETAILED DESCRIPTION OF THE INVENTION

While many products are marketed specifically towards young children, some children often lack the attention span or reading ability to consistently identify some products, and the child may not use the product in a manner consistent with the intended use of the product or may not be adequately encouraged to use the product at all. In accordance with the exemplary embodiments discussed herein, a system for enabling the child to identify the product in a product dispenser may include symbols or other preferably non-written identification elements which help a child to identify the type of product contained in a container. The identification element may further allow the user to “customize” the appearance of the dispenser so that the dispenser is attractive to him or her or the user. The identification element may be removable and changed, periodically, in order to keep the user's interest. The identification element may also be removable and used as a reward. The identification element may be integral with another portion of the dispenser, such as the shaped element.

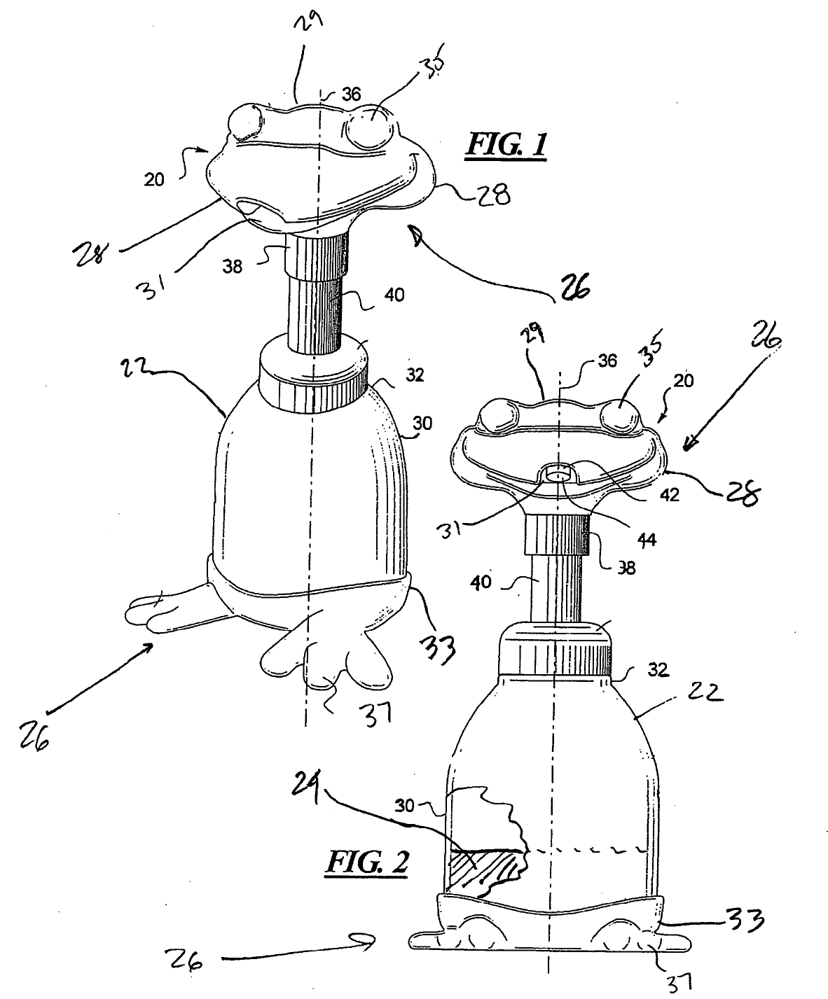

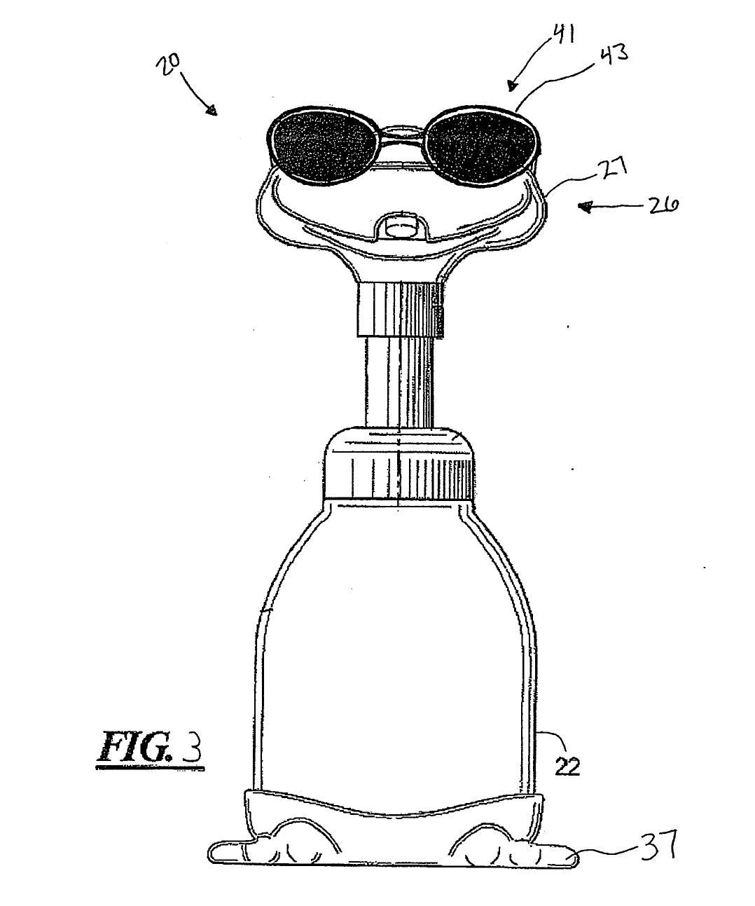

Referring now to FIGS. 1 and 2, an identification system for a product dispenser assembled in accordance with the teachings of the present invention is shown and is referred to generally by the reference numeral 20. The system 20 includes a product container 22 which may hold a dispensable product 24 (shown in the partial cutaway of FIG. 2). The system 20 includes a shaped feature 26 which, in the disclosed example, is mounted on the product container 22. In the example of FIGS. 1 and 2, the shaped feature 26 takes the form of an anthropomorphic character 28. Also in the example of FIGS. 1 and 2, the anthropomorphic character 28 may have a number of body parts, including by way of example rather than limitation, a head 29 having a mouth 31 and eyes 35, as well as limbs in the form of feet 37 or in the form of hands and feet 39 (FIG. 5). The shaped feature 26 may also include other specific body parts or other characteristics such as, for example, fingers, toes, ears, hair, teeth, etc. Other shaped features may prove suitable, including, by way of example rather than limitation, other anthropomorphic shapes, characters including cartoon characters including rabbits or mice, animals, clowns, scary or frightening characters, humans, pirates, soldiers, movie characters, wizards, etc. The system 20 also includes an identification symbol, which is discussed in greater detail below with respect to FIGS. 3-6.

The product 24 contained in the product container 22 may be a liquid, solid, gel, or other suitable product, or may be a combination of such products. For example, the product 24 may be hand soap, body soap, bubble bath, shampoo, baby powder, toothpaste, lotion, or other personal hygiene products. The product 24 may also be sunscreen, condiments, catsup, mustard, salad dressing, drink mixes, or other dispensable products. The foregoing exemplary products are illustrative only and are not intended to limit the type of dispensable product in any way.

In the example of FIGS. 1 and 2, the container 22 includes a side wall 30 extending upwardly from a bottom or base 33. The illustrated side wall 30 has an upper portion that is tapered to form a neck 32. The exemplary container 22 preferably is operable to dispense the product 24 and thus may include a dispensing mechanism, such as a pump 38, coupled to the container 22 and operable to dispense the product 24 from the container 22. The pump 38 may be coupled to the container 22 using any known type of fastener, such as a threaded-engagement, snap-engagement, adhesive-bonding, and the like, between the container neck 32 and a collar provided with the pump 38. The pump 38 may be of a conventional design commonly used in products such as hand lotions and liquid soaps and other dispensable products. The pump 38 preferably includes an internal tube (not shown) extending downwardly into the container 22 and a pump shaft 40 defining an actuating axis 36 along which the shaft 40 may be reciprocated to generate a pressure which draws product up the tube. A pump head 42 (FIG. 2) may be attached to the pump shaft 40 and may define a discharge opening 44 (FIG. 2), such that the product 24 may be drawn through the tube, through the pump shaft 40 and the pump head 42 to exit at the discharge opening 44. The pump head 42 may also define an upper surface against which a dispensing force may be applied to actuate the pump head 42 and attached shaft 40, thereby to discharge the product from the container 22.

As would be known, in order to operate the pump 38, a dispensing force is applied by a user with sufficient magnitude and in the proper direction to actuate the head 42 and shaft 40. In the illustrated embodiment, the direction in which the dispensing force is to be applied is defined by the pump shaft 40, which reciprocates along the actuating axis 36 defined by the shaft. As shown in FIG. 2, the pump shaft 40 is axially aligned with a longitudinal container axis, and therefore the dispensing force direction is also coincident with the longitudinal container axis in the illustrated embodiment. It is not necessary, however, for the pump shaft 40 to be aligned with the longitudinal container axis and the dispensing force direction need not be coincident with the longitudinal container axis. Furthermore, while a particular pump 38 has been illustrated and described herein, other types of pumps, as well as other dispensing mechanisms requiring application of a dispensing force may be provided without departing from the scope of this disclosure. Suitable pumps are available from Airspray NV of Alkmaar, The Netherlands. The container 22 also may be adapted to dispense the product 24 using aerosols or any other suitable technology.

In the illustrated embodiment, the product container 22 is intended to be used in an upright position, in which the container 22 rests flush on a container bottom. When in the normal dispensing position, actuation of the pump shaft 40 will cause product to be dispensed toward the target area. The target area may be located in a direction generally downwardly from the discharge opening 44 and away from the container side wall 30, such as the area where a user would place his or her hands adjacent a liquid soap dispenser during use. The target area may, however, be located in other areas with respect to the product dispenser 24.

As stated above, regardless of the type of product 24 contained in the container 22, some users (not shown), such as children, cannot read and will not know what product 24 is in the container 22. However, most children can recognize symbols from a very young age. Thus, symbolically identifying the product 24 within the container 22 allows, in accordance with the disclosed example, virtually any child to identify the product 24 and to recognize the intended use of the product 24.

Referring now to FIG. 3, as outlined above the system 20 includes an identification symbol 41 which, in the disclosed example is preferably non-written and preferably facilitates the recognition by the user of the type or nature of the product contained in the container 22 and/or the intended use of that product. In the example of FIG. 3, the shaped feature 26 includes a frog head 27 and the identification symbol 41 takes the form of sunglasses 43 covering the eyes on the frog head 27. In accordance with the disclosed example, the sunglasses 43 thus suggest the nature of the product as being a sunscreen. The shaped feature 26 also may include feet 37, as well as hands or other features (not shown in FIG. 3). It will be understood that the sunglasses need not be actual sunglasses, but instead may be structured to resemble sunglasses. Still other features and identification symbols may be contemplated to suggest that the product is sunscreen such as other symbols typically associated with the beach and/or other sunny climes. Non-limiting examples of such identification symbols include a towel, sun-hat, life-preserver, diving equipment or a parasol.

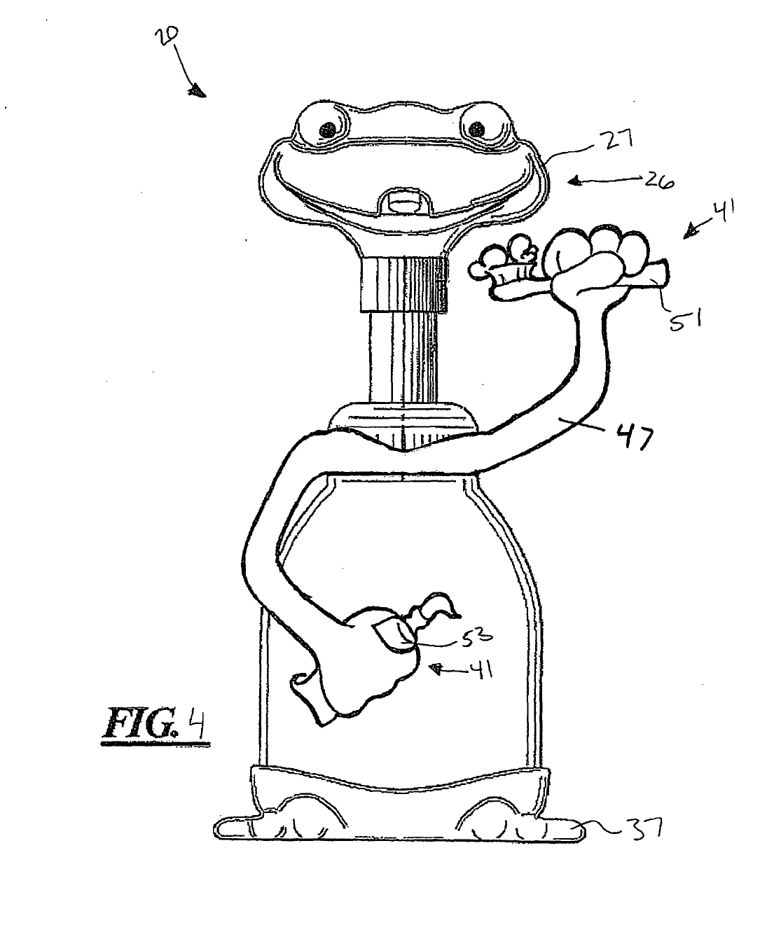

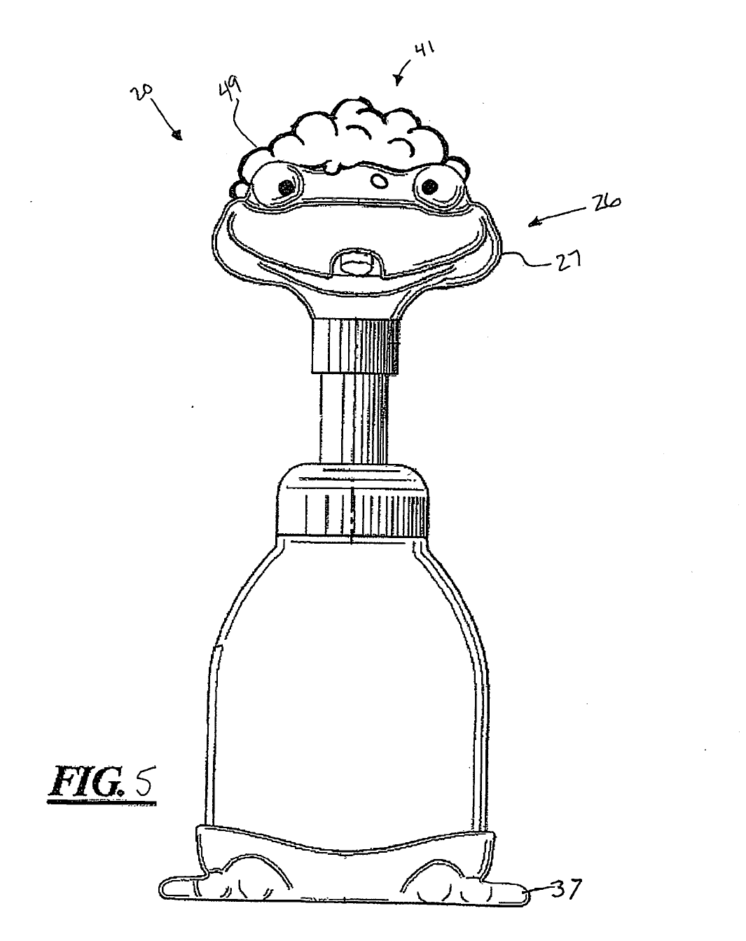

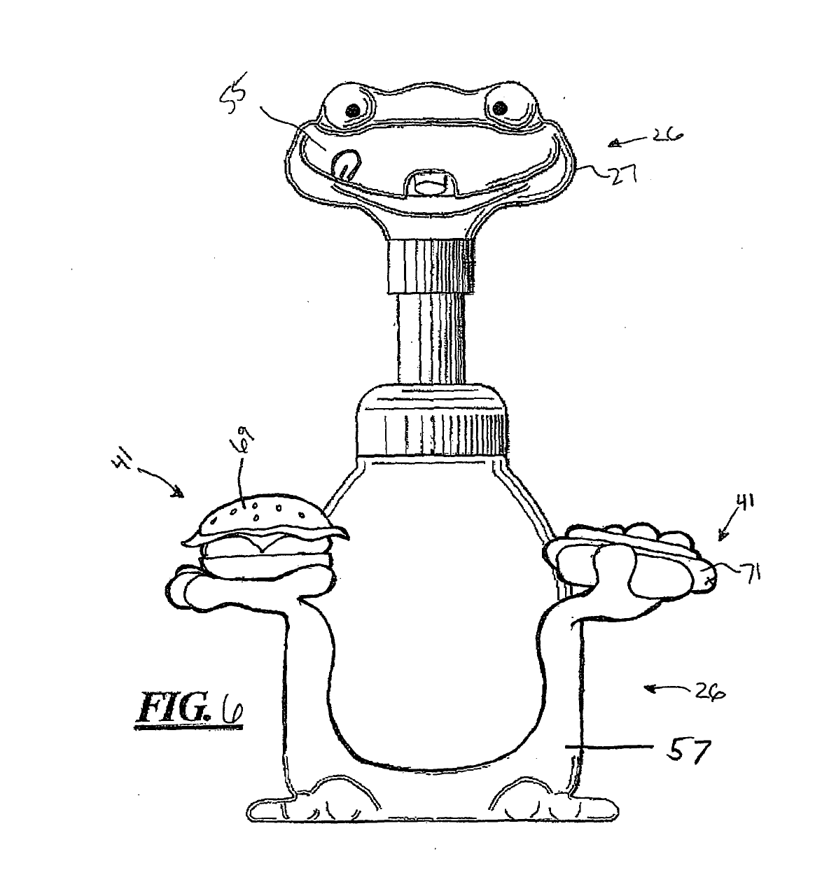

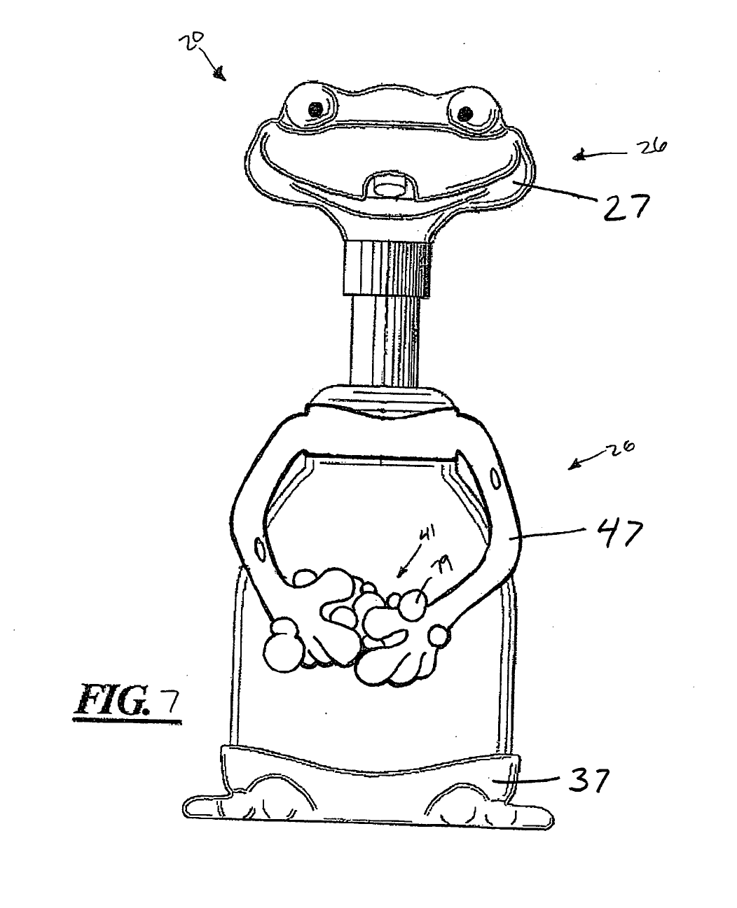

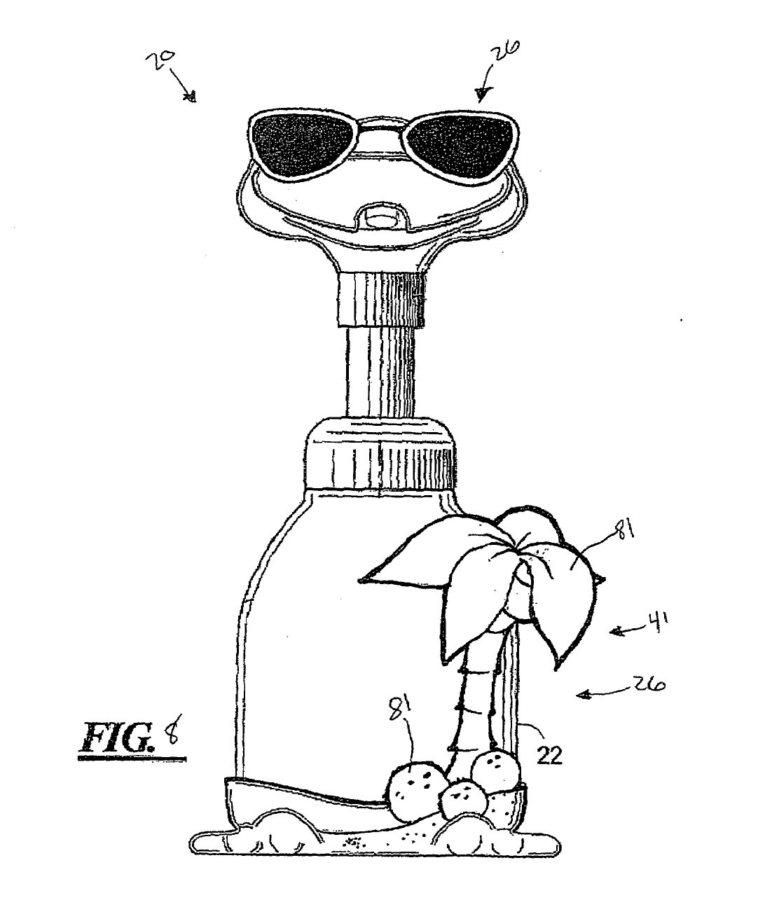

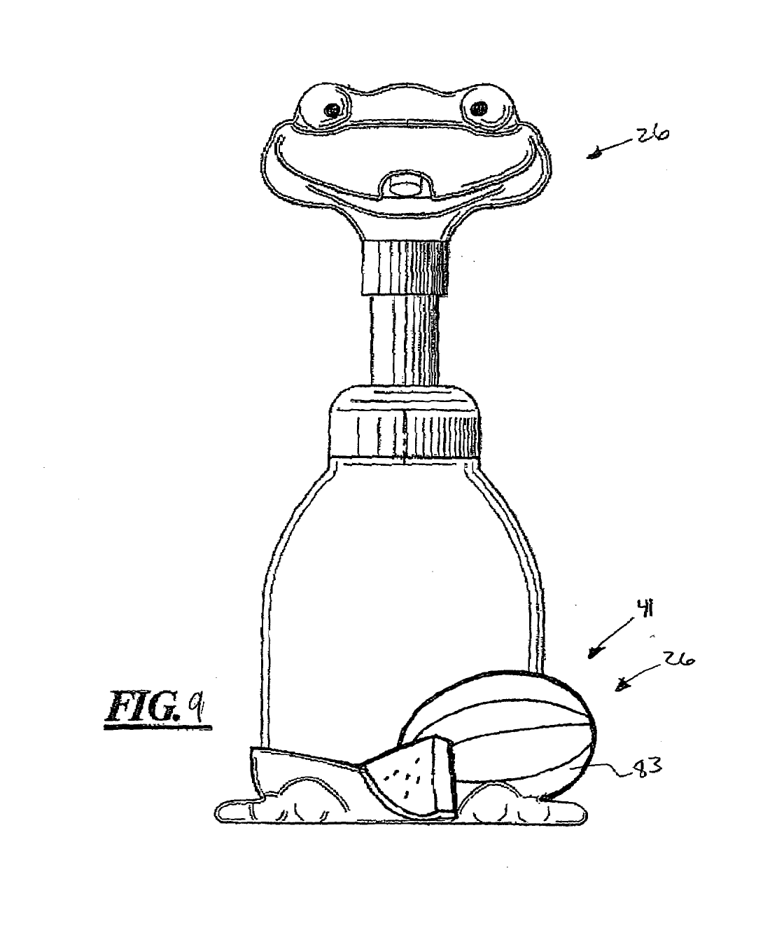

In the example of FIG. 4 depicts a system 20 that includes a shaped feature 26 that again includes a frog head 27 and feet 37 and further includes arms-and-hands 47, and the identification symbol 41 takes the form a toothbrush 51 in one hand of the arms-and-hands 47 and having a brush portion disposed adjacent a mouth of the frog head 27 and a second identification symbol 41 that takes the form of a tube of toothpaste 53 in the other hand of the arms-and-hands 47. In accordance with the disclosed example, the toothbrush 51 and tube of toothpaste 53 thus suggest that the nature of the product is toothpaste. It will be understood that the toothbrush and tube of toothpaste need not be an actual toothbrush or tube of toothpaste, but instead may be structured to resemble a toothbrush and tube of toothpaste.

In the example of FIG. 5, the system 20 again includes a shaped feature 26 that again includes a frog head 27 and feet 37, and the identification symbol 41 takes the form of bubbles 49 on top of the frog head 27. In accordance with the disclosed example, the bubbles 49 on top of the frog head 27 thus suggest that the nature of the product is shampoo. It will be understood that the bubbles need not be actual bubbles, but instead may be structured to resemble bubbles. Still other features and identification symbols may be contemplated to suggest that the product is shampoo. Alternative non-limiting identification symbols that could represent shampoo may be, for example, a small shampoo bottle (not shown).

In the example of FIG. 6, the shaped feature 26 again includes a frog head 27 and further includes hands-and-feet as a single unit 57 and the identification symbols 41 takes the form of a hamburger 69 or hotdog 71 in the hands of the hands-and-feet unit 57. In accordance with the disclosed example, the hamburger 69 and/or hotdog 71 thus suggest the nature of the product (condiments) to the user. It will be understood that the hamburger and/or hotdog need not be actual hamburger and or hotdogs, but instead may be structured to resemble hamburgers and/or hotdogs. Still other features and identification symbols may be contemplated to suggest that the product is condiments. Alternative non-limiting identification symbols that could represent condiments may be, for example, a lip-smacking tongue 55 on the head feature, and/or a sandwich (not shown). Virtually any dispensable product could be represented symbolically in this manner to facilitate identification of the product.

Moreover, more general representations may be made of the product 24 within the container 22. For example, in FIG. 6, one identification symbol 41 takes the form of a tongue 55 licking lips. In this example, the tongue 55 may identify edible products. Other general representations may be made as well.

In the example of FIG. 7, the system 20 includes a shaped feature 26 that again includes a frog head 27 and feet 37 and arms-and-hands 47, and the identification symbol 41 takes the form of bubbles 79 on the hands of the arms-and-hands 47. In accordance with the disclosed example, the bubbles 79 on the hands of the arms-and-hands 47 suggest that the nature of the product is hand soap. It will be understood that the bubbles need not be actual bubbles, but instead may be structured to resemble bubbles. Still other features and identification symbols may be contemplated to suggest that the product is hand soap. Alternative non-limiting identification symbols that could represent toothpaste may be, for example, a washcloth, a small bar of soap, or dirty hands (not shown).

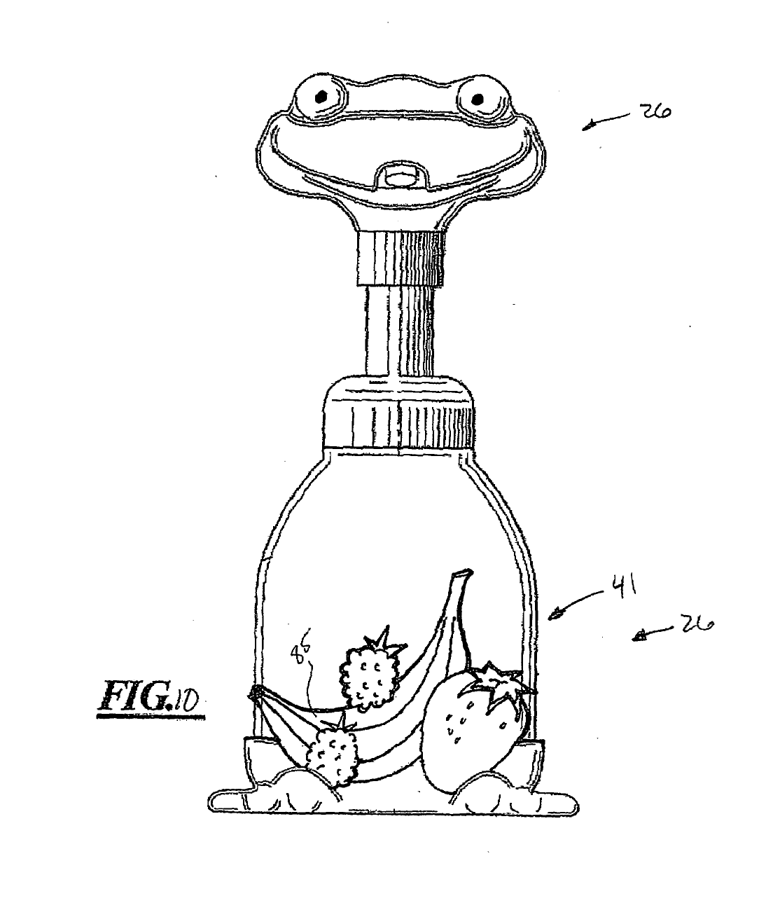

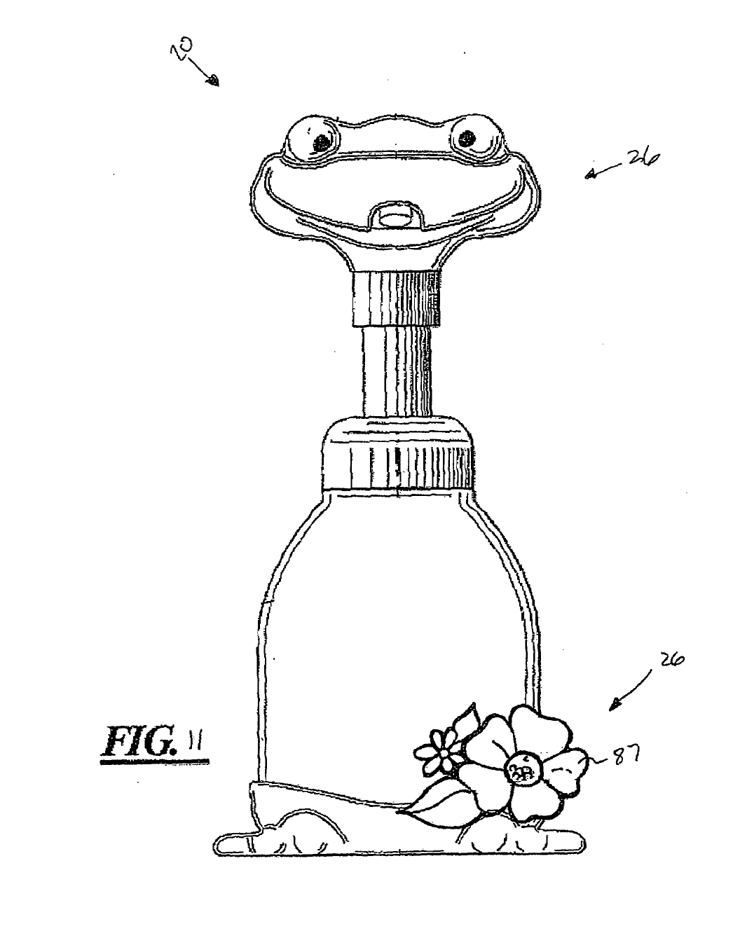

The identification symbol may alternatively be used to indicate the scent of the product 24 in the container 22 of the system 20. The example of FIG. 8 shows a system 20 including a shaped feature 26 and an identification symbol 41 which takes the form of a palm tree and coconuts 81. In accordance with the disclosed example, the palm tree and coconuts 81 suggest that the product has a tropical fragrance. Similarly FIG. 9 shows the shaped feature 26 and an identification symbol 41 which takes the form of a watermelon 83. In accordance with the disclosed example, the watermelon 83 suggests that the product has a watermelon fragrance. Likewise, FIG. 10 shows the shaped feature 26 and the identification symbol 41 which takes the form of a fruit 85. In accordance with the disclosed example, the fruit 85 suggests that the product has a fruity fragrance.

The identification symbols can also be used to tailor the attractiveness of the product dispenser system to the preferences of the individual user(s), including preferences based on gender or other individual preferences. For example, the user may be a female child and that female child may find flowers or teddy bears to be attractive and the female child may be encouraged to use the product contained in the container if the dispensing system were decorated so that the shaped feature included an identification symbol of flowers and/or a teddy bear. Similarly a male child may find it attractive that the dispensing system includes identification symbols on the shaped feature such as a football helmet or other sports-related identification symbol. Additionally, the attractiveness of the dispensing system can be maintained, particularly as the preferences of the user change, as the identification symbols can be made to be removable, and can then be removed and replaced with different identification symbols given the changing preferences of the user, or the different preferences of different users.

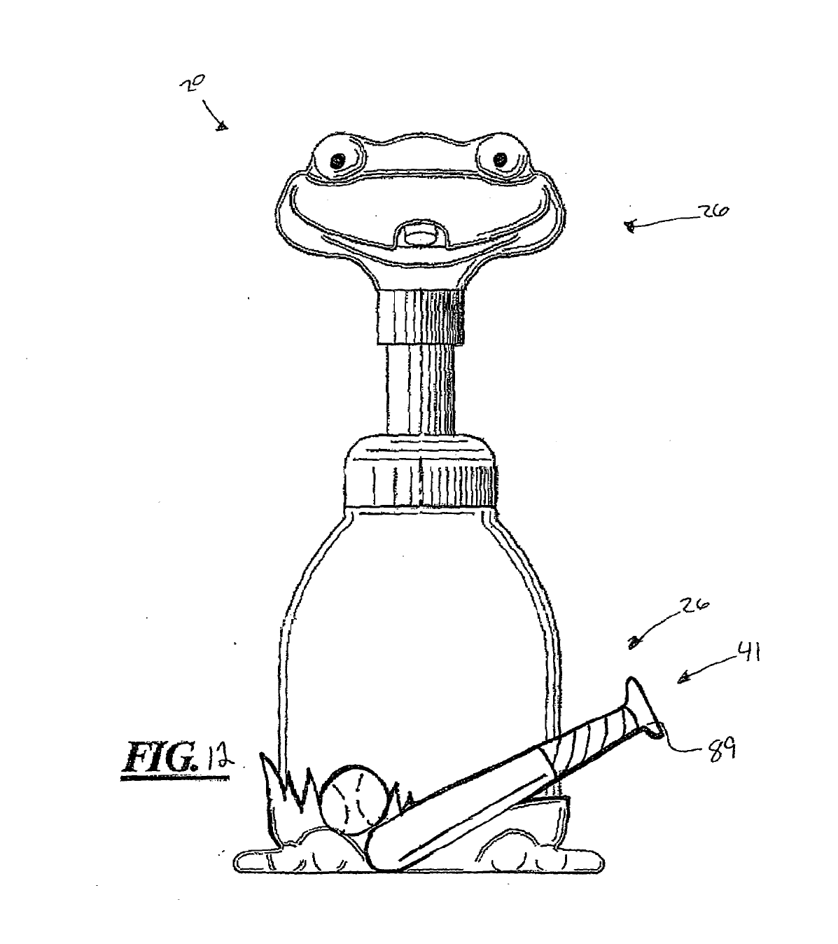

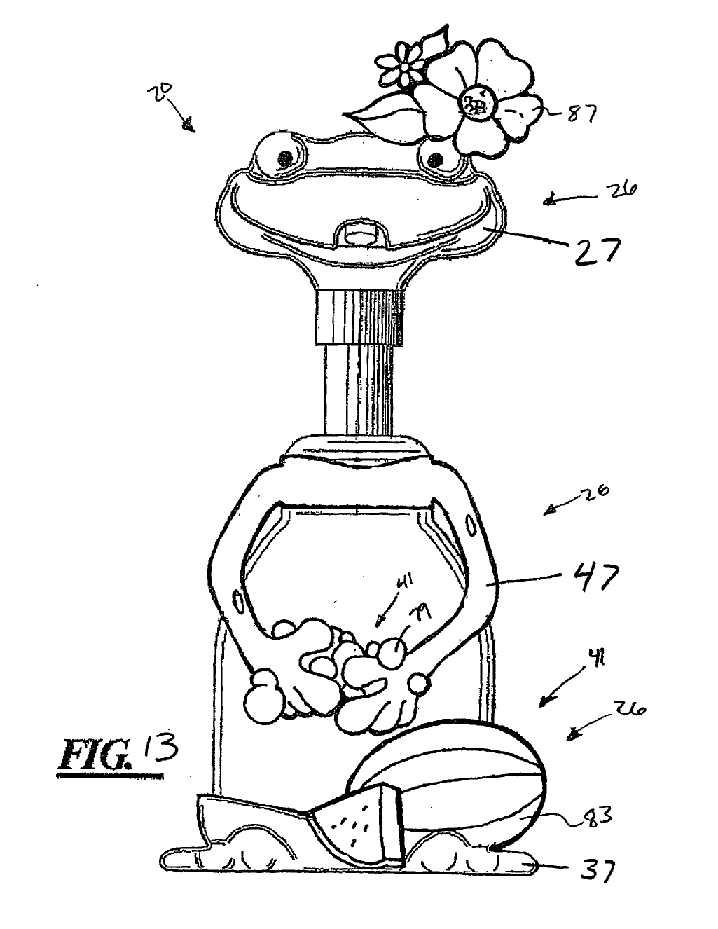

For example, FIG. 11 shows a system 20 including a shaped feature 26 and the identification symbol 41 which takes the form of a bunch of flowers 87. In accordance with the disclosed example, the bunch of flowers 87 suggests that the product is a product that is used by girls. On the other hand, FIG. 12 shows a system 20 that includes a shaped feature 26 and the identification symbol 41 which takes the form of a bat and ball 89. The bat and ball 89 suggest that the product is a product that is used by boys.

It will be understood that the palm tree and coconuts, watermelon, fruit, bunch of flowers, and bat and ball need not be actual palm trees and coconuts, watermelon, fruit, bunches of flowers, or bats and balls, but instead may be structured to resemble palm trees and coconuts, watermelon, fruit, bunches of flowers, and bats and balls. Still other features and identification symbols may be contemplated to suggest the product's fragrance or use by gender.

As can be appreciated from the aforementioned disclosure and examples of dispenser systems 20 comprising shaped features 26 and identification symbols 41 that multiple identification symbols 41 can be envisioned as being applied in a single dispensing system 20 comprising a single shaped feature 26 in order to most fully indicate the product 24 contained therein. For example, a hand soap product with a watermelon fragrance for use by a girl might include the multiple identification symbols of bubbles on the hand, a watermelon, and a flower. FIG. 13 depicts such an arrangement of multiple identification symbols with the system 20 including a shaped feature 26 that includes a frog head 27 and feet 37 and arms-and-hands 47 and the identification symbols 41 taking the form of flowers 87 on the frog head 27 and bubbles on the hands of the arms-and-hands 47 and a watermelon near the feet of the feet 37. Still other combinations of identification symbols for the dispensing system can be contemplated that more fully define other products.

The shaped feature 26 may be removably attached to the dispenser to facilitate replacement of the shaped feature 26 when the child begins to prefer a different character representation, such as in the case where the child may loose interest in the first character representation. For example, as the child grows, the frog head of FIGS. 1 and 2 may be replaced with the child's favorite cartoon character or animal. The child's favorite character or animal may be used as the shaped feature 26 for products that the child uses often. On the contrary, a scary shaped feature 26 may be placed on a container that dispenses a product that the child should not use. The example of a scary shaped figure illustrates the further point that the shaped FIG. 26, itself, may also serve the function of the identification symbol 41.

Furthermore, the identification symbols (sunglasses, diving mask, snorkel, bubbles, toothbrush, etc.) may be removably attached to the shaped feature 26. This would allow that a same shaped feature 26 may be used on a plurality of dispenser systems 20 of different products 24. For example, a parent may wish to use the shaped feature 26 that formerly was attached to a container 22 of a product 24 that was a shampoo product, and re-attach that same shaped feature 26 to a container 22 that contains a hand soap or sunscreen product. In this case bubbles 49 on the head of the shaped feature 26 would be removed and replaced with bubbles 79 on the hand of the shaped feature 26 or replaced with sunglasses on the head of the shaped feature (respectively).

The identification symbols can be removably attached to the shaped feature by any one of a number of means commonly known in the art. Non-limiting examples of means by which the identification symbol may be removably attached to the shaped feature include magnets, hook-and-loop fastening, and hole-and-peg fastening (i.e. where the identification symbol includes a “peg” in addition to its other features, and the shaped feature includes a “hole” in the appropriate location for the insertion of the “peg”). The identification symbols may also be integral with the dispenser or other features which are removably attached to the dispenser.

Alternately, a parent may wish to re-use the container 22 and to incorporate a different product 24 into the container. This instance is particularly possible in the case where the container is designed to be refillable rather than disposable. As such, the parent may wish to change the product of the container 22 while still allowing the child to identify the product 24. For example, the parent may change the product 24 in the container 22 from hand soap to shampoo. In this case, bubbles 79 on the hands 39 or feet 37 of the shaped feature 26 (See FIG. 7) may be exchanged for bubbles 49 on the top of the shaped feature 26 (See FIG. 5).

An additional advantage of the removability of the identification symbols relative to the shaped figure is the “customization” of the appearance of the shaped figure to the preference of the user. For example, a product dispenser with a shaped figure and identification symbols intended for a female child may be customized to include flowers, rainbows, teddy-bears and the like whereas a product dispenser with a shaped figure and identification symbols intended for a male child may be customized to include a football helmet, racecars, weapons and the like. Multiple product dispensers would not be required to accommodate the preferences of multiple children in multi-child households, but rather the identification symbols could be removed and replaced to address the preferences of the multiple children. Additionally, identification symbols could be added and removed over time as the preferences of an individual user change, over time, thereby maintaining the attractiveness of the dispenser to the user without the need to purchase additional dispensers.

An additional advantage of the shaped feature 26 described herein is that changing the shaped feature 26 and/or adding different identification symbols may be used as a reward for the child. For example, if the child consistently brushes his/her teeth, the parent may allow the child to choose the animal or cartoon character for the shaped feature 26, or the preferred identification symbol 41 for the dispensing system 20. Not only does this reward the child, but the periodic change of the identification element helps hold the child's attention and keeps the child focused on the task at hand.

Table 1 below shows one example of a possible relationship between the identification symbol and the dispensed product.

TABLE 1
Exemplary Relationship Between Identification Symbol and Product

| | | Product | | | | | | | |
|---|---|---|---|---|---|---|---|---|---|
| | | Shampoo | Hand soap | Bubble Bath | Sunscreen | Condiments | Toothpaste | For a girl | For a boy |
| | Teeth | | | | | X | X | | |
| | Bubbles on | | X | X | | | | | |
| | hands | | | | | | | | |
| | Bubbles on | X | | X | | | X | | |
| | head/face | | | | | | | | |
| | Bubbles on | X | | X | | | | | |
| | body | | | | | | | | |
| | Sunglasses | | | | X | | | | X |
| Identification | Flowers | | | | | | | X | |
| Symbol | Sports | | | | | | | | X |
| | equipment | | | | | | | | |
| | Food item | | | | | X | | | |
| | (e.g., | | | | | | | | |
| | hamburger/ | | | | | | | | |
| | hotdog) | | | | | | | | |

Table 1 is shown as an example only. Other relationships between the identification symbol and the product are possible and may be determined by one of ordinary skill in the art.

All documents cited in the Detailed Description are, in relevant part, incorporated herein by reference; the citation of any document is not an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A system for indicating the contents of a product dispenser, the system comprising:
a product container arranged to contain a dispensable product;
the product dispenser including a shaped feature; and
a non-written identification symbol mounted on the shaped feature, the identification symbol structured to indicate the nature of the dispensable product to a user.

2. The system of claim 1, wherein the shaped feature comprises an anthropomorphic character.

3. The system of claim 2, wherein the anthropomorphic character includes a head.

4. The system of claim 1, wherein the shaped feature comprises a cartoon character.

5. The system of claim 1, wherein the product container is arranged to dispense soap, and wherein the identification symbol comprises bubbles.

6. The system of claim 1, wherein the product container is arranged to dispense a personal hygiene product and the shaped feature comprises an anthropomorphic character having a body part, and wherein the identification symbol includes bubbles on the body part associated with an intended use of the personal hygiene product.

7. The system of claim 6, wherein the personal hygiene product is hand soap and wherein the body part comprises hands.

8. The system of claim 6, wherein the personal hygiene product is shampoo and wherein the body part comprises a head.

9. The system of claim 6, wherein the personal hygiene product is toothpaste and the body part comprises a mouth or teeth, and wherein the identification symbol is a toothbrush.

10. The system of claim 1, wherein the product container is arranged to dispense sunscreen and the shaped feature comprises an anthropomorphic character having eyes, and wherein the identification symbol comprises sunglasses.

11. The system of claim 1, wherein the product container is arranged to dispense condiments, and wherein the identification symbol is structured to resemble food.

12. The system of claim 1, wherein the shaped feature is removable.

13. The system of claim 12, wherein the identification symbol is removably attached to the shaped feature.

14. The system of claim 1, further comprising a second non-written identification symbol, the second identification symbol also structured to indicate the nature of the dispensable product to a user.

15. The system of claim 1, wherein the shaped feature comprises an anthropomorphic character having a selected body part comprising one of a head, upper limbs, or lower limbs, and wherein the identification symbol is mounted to the selected body part, and further wherein the product container is arranged to dispense product associated with the selected body part.

16. A product dispenser comprising:
a product container containing a dispensable product:
a shaped feature coupled to the product container;
and a non-written, removable, three dimensional, identification or ornamentation structure disposed on said shaped feature.

17. A system for indicating the contents of a product dispenser, the system comprising:
a product container containing a dispensable product;
a shaped feature coupled to the product container; and
a non-written identification symbol coupled to either the product dispenser or the shaped feature, the identification symbol structured to facilitate the identification of the dispensable product by an intended user of the dispensable product.

18. The system of claim 17, wherein the shaped feature comprises a removable housing arranged to house the product dispenser.

19. The system of claim 17, wherein the product is a personal hygiene product and the shaped feature comprises an anthropomorphic character having a body part associated with an intended use of the personal hygiene product.

20. The system of claim 19, wherein the product is hand soap and the body part comprises hands, and wherein the identification symbol is structured to resemble bubbles.

21. The system of claim 19, wherein the product is shampoo and the body part comprises a head, and wherein the identification symbol is located on the head and is structured to resemble bubbles.

22. The system of claim 19, wherein the product is toothpaste and the body part comprises a mouth or teeth, and wherein the identification symbol is structured to resemble a toothbrush.

23. The system of claim 17, wherein the product is sunscreen and the shaped feature comprises an anthropomorphic character having a body part structured to resemble eyes, and wherein the identification symbol is structured to resemble sunglasses.

24. The system of claim 1, wherein the product is condiments, and wherein the identification symbol is structured to resemble food.

25. The system of claim 1, wherein the identification symbol is structured to represent a scent element incorporated into the product.

26. A method of facilitating identification of a product in a container, the method comprising:
providing a product in a container;
mounting a shaped feature on the container;
providing a non-written identification symbol on the shaped feature;
wherein the identification symbol indicates the nature of the dispensable product to a user.
